(19) United States
(12) Patent Application Publication
(10) Pub. No.: US 2010/0131268 A1
(43) Pub. Date: May 27, 2010

(54) VOICE-ESTIMATION INTERFACE AND COMMUNICATION SYSTEM

(75) Inventor: Lothar Benedikt Moeller, Middletown, NJ (US)

Correspondence Address: MENDELSOHN, DRUCKER, & ASSOCIATES, P.C., 1500 JOHN F. KENNEDY BLVD., SUITE 405, PHILADELPHIA, PA, 19102, US

(73) Assignee: ALCATEL-LUCENT USA INC., Murray Hill, NJ (US)

(21) Appl. No.: 12/323,525

(22) Filed: Nov. 26, 2008

(51) Int. Cl. G10L 15/20

(52) U.S. Cl. 704/233; 704/E15.039

(57) ABSTRACT

An apparatus having a voice-estimation (VE) interface that probes the vocal tract of a user with sub-threshold acoustic waves to estimate the user's voice while the user speaks silently or audibly in a noisy or socially sensitive environment. In one embodiment, the VE interface is integrated into a cell phone that directs an estimated-voice signal over a network to a remote party to enable (i) the user to have a conversation with the remote party without disturbing other people, e.g., at a meeting, conference, movie, or performance, and (ii) the remote party to more-clearly hear the user whose voice would otherwise be overwhelmed by a relatively loud ambient noise due to the user being, e.g., in a nightclub, disco, or flying aircraft.

### BACKGROUND OF THE INVENTION

1. Field of the Invention

The present invention relates to communication equipment and, more specifically, to speech-recognition devices and communication systems employing the same.

2. Description of the Related Art

This section introduces aspects that may help facilitate a better understanding of the invention(s). Accordingly, the statements of this section are to be read in this light and are not to be understood as admissions about what is in the prior art or what is not in the prior art.

Although the use of cell phones has been rapidly proliferating over the last decade, there are still circumstances in which the use of a conventional cell phone is not physically feasible and/or socially acceptable. For example, a relatively loud background noise in a nightclub, disco, or flying aircraft might cause the speech addressed to a remote party to become inaudible and/or unintelligible. Also, having a cell-phone conversation during a meeting, conference, movie, or performance is generally considered to be rude and, as such, is not normally tolerated. Today's response to most of these situations is to turn off the cell phone or, if physically possible, leave the noisy or sensitive area to find a better place for a phone call.

### SUMMARY OF THE INVENTION

Problems in the prior art are addressed by a voice-estimation (VE) interface that probes the vocal tract of a user with sub-threshold acoustic waves to estimate the user's voice while the user speaks silently or audibly in a noisy or socially sensitive environment. In one embodiment, the VE interface is integrated into a cell phone that directs an estimated-voice signal over a network to a remote party. Advantageously, the VE interface enables the user to have a conversation with the remote party without disturbing other people, e.g., at a meeting, conference, movie, or performance, and enables the remote party to more-clearly hear the user whose voice would otherwise be overwhelmed by a relatively loud ambient noise due to the user being, e.g., in a nightclub, disco, or flying aircraft.

According to one embodiment, the present invention is an apparatus having: (i) a VE interface adapted to probe a vocal tract of a user; and (ii) a signal-converter (SC) module operatively coupled to the VE interface and adapted to process one or more signals produced by the VE interface to generate an estimated-voice signal corresponding to the user. The VE interface comprises a sub-threshold acoustic (STA) package adapted to direct STA bursts to the vocal tract and detect echo signals corresponding to the STA bursts. The estimated-voice signal is based on the echo signals.

According to another embodiment, the present invention is a method of estimating voice having the steps of: (A) probing a vocal tract of a user using a VE interface; and (B) processing one or more signals produced by the VE interface to generate an estimated-voice signal corresponding to the user. The VE interface comprises an STA package adapted to direct STA bursts to the vocal tract and detect echo signals corresponding to the STA bursts. The estimated-voice signal is based on the echo signals.

### BRIEF DESCRIPTION OF THE DRAWINGS

Other aspects, features, and benefits of the present invention will become more fully apparent from the following detailed description, the appended claims, and the accompanying drawings in which:

FIGS. 1A-B illustrate a communication system according to one embodiment of the invention;

FIG. 2 shows the anatomy of the human vocal tract;

FIGS. 3A-C show a cell phone that can be used as a transceiver in the communication system of FIG. 1 according to one embodiment of the invention;

FIGS. 4A-B graphically show two representative echo signals detected by the cell phone of FIG. 3;

FIG. 5 shows a flowchart of a signal-processing method that can be used by a signal-converter (SC) module in the communication system of FIG. 1 according to one embodiment of the invention; and

FIGS. 6A-B illustrate a signal-processing method that can be used by an SC module in the communication system of FIG. 1 according to another embodiment of the invention.

### DETAILED DESCRIPTION

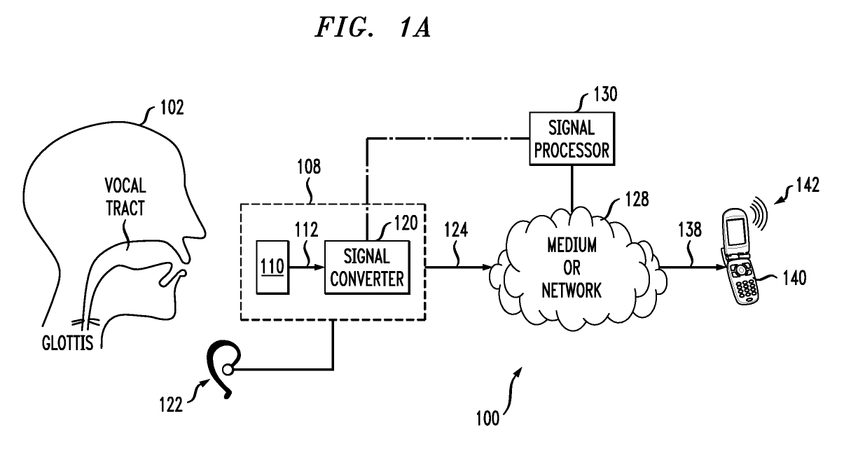

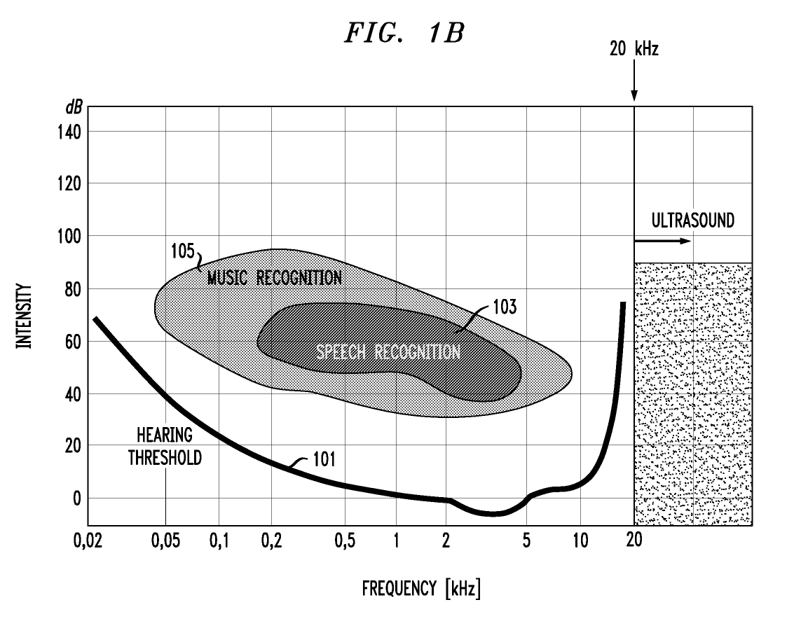

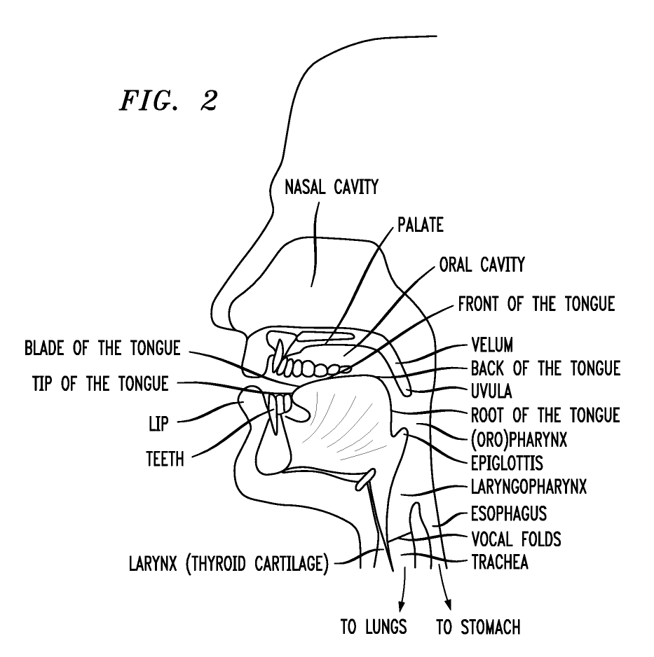

FIG. 1A shows a block diagram of a communication system 100 according to one embodiment of the invention. System 100 has a voice-estimation (VE) interface 110 that can be positioned in relatively close proximity to the face of a person 102. VE interface 110 can be used, e.g., to detect silent speech or to enhance the perception of normal speech when it is superimposed onto or substantially overwhelmed by a relatively noisy acoustic background. The phenomenon of silent speech is explained in more detail below in reference to FIG. 2.

VE interface 110 has one or more sensors (not explicitly shown) designed to collect one or more signals that characterize the vocal tract of person 102. In various embodiments, VE interface 110 might include (without limitation) one or more of the following sensors: a video camera, an infrared sensor or imager, a sub-threshold acoustic (STA) sensor, a millimeter-wave sensor, an electromyographic sensor, and an electromagnetic articulographic sensor. In a representative embodiment, VE interface 110 has at least an STA sensor.

FIG. 1B graphically illustrates STA waves. More specifically, a curve 101 in FIG. 1B shows a physiological-perception threshold for human hearing in the audio range (i.e., between about 15 Hz and about 20 kHz) in a quiet environment. Sound waves with frequencies from the audio range are normally perceptible if their intensity is above curve 101. In particular, optimal perception of speech and music is observed within the frequency-intensity ranges indicated by regions 103 and 105, respectively. However, if the intensity of a sound wave falls below curve 101, then that sound wave becomes imperceptible to the human ear. In addition, ultrasound waves (i.e., quasi-acoustic waves whose frequency is higher than the upper boundary of the audio range) are normally imperceptible to the human ear. As used herein, the term “sub-threshold acoustic” or “STA” encompasses both (A) sound waves from the audio-frequency range whose intensity is below a physiological-perception threshold and (B) ultrasound waves.

Note that the shape and position of curve 101 are functions of background noise. More specifically, if the background noise is a “white” noise and its intensity increases, then curve 101 generally shifts up on the intensity scale. If the background noise is not “white,” i.e., has pronounced frequency bands, then the spectral shape of curve 101 might change accordingly. Furthermore, different people might have different physiological-perception thresholds.

With respect to VE interface 110, it is beneficial to have its STA functionality referenced to a physiological-perception threshold of a typical neighbor of person 102, and not to that of person 102. One reason for this type of referencing is that system 100 is designed with an understanding that, in certain modes of operation, VE interface 110 should not disturb other people around person 102. As a result, a physiological-perception threshold of a typical neighbor of person 102 ought to be factored in. In a representative embodiment, VE interface 110 operates so that, at a distance of about one meter, an average person does not perceive any bothersome effects of its operation. VE interface 110 might receive an input signal from a microphone configured to measure background acoustic noise and use that information to adjust its STA excitation pulses, e.g., so that their intensity is relatively high, but still remains imperceptible to a putative neighbor of person 102.

Referring back to FIG. 1A, one or more output signals 112 generated by the one or more sensors of VE interface 110 are applied to a signal-converter (SC) module 120 that processes them to generate a unified estimated-voice signal corresponding to the silent or noise-burdened speech of person 102. In one embodiment, the unified estimated-voice signal comprises a sequence of phonemes corresponding to the voice of person 102. In another embodiment, the unified estimated-voice signal comprises an audio signal that can be used to produce a regular perceptible sound corresponding to the voice of person 102. SC module 120 might use a digital signal processor (DSP) and/or an artificial neural network to generate the unified estimated-voice signal.

In one embodiment, VE interface 110 and SC module 120 are parts of a transceiver (e.g., cell phone) 108 connected to a wireless, wireline, and/or optical transmission system, network, or medium 128. Cell phone 108 uses the unified estimated-voice signal generated by SC module 120 to generate a communication signal 124 that can be transmitted, in a conventional manner, over network 128 and be received as part of a communication signal 138 at a remote transceiver (e.g., cell phone) 140. Transceiver 140 processes communication signal 138 and converts it into a sound 142 that phonates the estimated-voice signal. Transceiver 108 might have an earpiece 122 that can similarly phonate the estimated-voice signal for person 102. Earpiece 122 plays a sound that is substantially similar to sound 142, which enables person 102 to make adjustments to her speech so that it becomes better perceptible at remote transceiver 140. Earpiece 122 can be particularly useful when the speech of person 102 is silent speech. In various embodiments, transceiver 108 can be a walkie-talkie, a head set, or a one-way radio. In one implementation, earpiece 122 can be a regular speaker of a cell phone. In another implementation, earpiece 122 can be a separate speaker dedicated to providing audio feedback to person 102 about her own speech.

If the processing power of SC module 120 is relatively low, then additional processing outside transceiver 108 might be necessary to generate a unified estimated-voice signal that appropriately represents the signals generated by the various sensors of VE interface 110. For such additional processing, system 100 might use a signal processor (e.g., a server) 130 connected to network 128. In one implementation, signal processor 130 can employ various speech-recognition and/or speech-synthesis techniques. Representative techniques that can be used in signal processor 130 are disclosed, e.g., in U.S. Pat. Nos. 7,251,601, 6,801,894, and RE 39,336, all of which are incorporated herein by reference in their entirety.

In an alternative embodiment, SC module 120 can be implemented as part of a server connected to network 128. Signal processor 130 can be implemented in transceiver 140. One skilled in the art will appreciate that other arrangements having SC module 120 and signal processor 130 at various physical locations within system 100 are also possible. In one embodiment, signal 124 and/or signal 138 can carry a sequence of phonemes and be substantially analogous to a text-message signal. In one embodiment, signal 138 can be converted into text, which is then displayed on a display screen of transceiver 140 in addition to or instead of being played as sound 142. Alternatively, signal 138 can be a regular cell-phone signal similar to those conventionally received by cell phones. Similarly, signal 124 can be converted into text, which is then displayed on a display screen of transceiver 108 in addition to or instead of being played as sound on earpiece 122.

FIG. 2 shows the anatomy of the human vocal tract. Sounds in speech are produced by an air stream that passes through the vocal tract. The air stream can be either egressive (i.e., with the air being exhaled through the mouth and/or nose) or ingressive (i.e., with the air being inhaled). Lungs serve as an air pump that generates the air stream. The vocal folds (also often referred to as vocal cords) extending across the opening of the larynx in the upper part of the trachea convert the kinetic energy of the air stream into audible sound. Various articulators of the vocal tract then transform the sound into intelligible speech.

Cartilage structures of the larynx can rotate and tilt variously to change the configuration of the vocal folds. When the vocal folds are open, breathing is permitted. The opening between the vocal folds is known as the glottis. When the vocal folds are closed, they form a barrier between the laryngopharynx and the trachea. When the air pressure below the closed vocal folds (i.e., sub-glottal pressure) is sufficiently high, the vocal folds are forced open. As the air begins to flow through the glottis, the sub-glottal pressure drops and both elastic and aerodynamic forces return the vocal folds into the closed state. After the vocal folds close, the sub-glottal pressure builds up again, thereby forcing the vocal folds to reopen and pass air through the glottis. Consequently, the sub-glottal pressure drops, thereby causing the vocal folds to close again. This periodic process (known as phonation) produces a sound corresponding to the configuration of the vocal folds and can continue for as along as the lungs can build up sufficient sub-glottal pressure.

The sound produced by the vocal folds is modified as it passes through the upper portion of the vocal tract. More specifically, various chambers of the vocal tract act as acoustic filters and/or resonators that modify the sound produced by the vocal folds. The following principal chambers of the vocal tract are usually recognized: (i) the pharyngeal cavity located between the esophagus and the epiglottis; (ii) the oral cavity defined by the tongue, teeth, palate, velum, and uvula; (iii) the labial cavity located between the teeth and lips; and (iv) the nasal cavity. The shapes of these cavities and, therefore, their acoustic properties can be changed by moving the various articulators of the vocal tract, such as the velum, tongue, lips, jaws, etc.

Silent speech is a phenomenon in which the above-described machinery of the vocal tract is activated in a normal manner, except that the vocal folds are not being forced to oscillate. The vocal folds will not oscillate if they are (i) not sufficiently close to one another, (ii) not under sufficient tension, or (iii) under too much tension, or if the pressure differential across the larynx is not sufficiently large. A person can activate the machinery of the vocal tract when she speaks to herself, i.e., “speaks” without producing a sound or by producing a sound that is below the physiological-perception threshold. By going through a mental act of “speaking to oneself,” a person subconsciously causes the brain to send appropriate signals to the muscles that control the various articulators in the vocal tract while preventing the vocal folds from oscillating. It is well known that an average person is capable of silent speech with very little training or no training at all. One skilled in the art will also appreciate that silent speech is different from whisper.

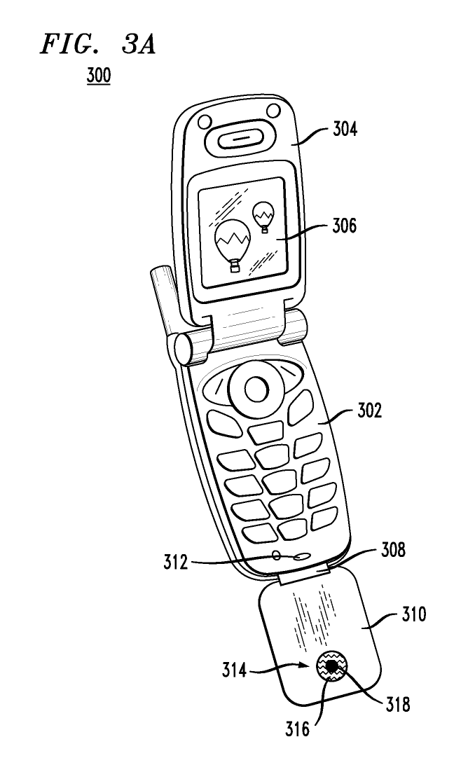

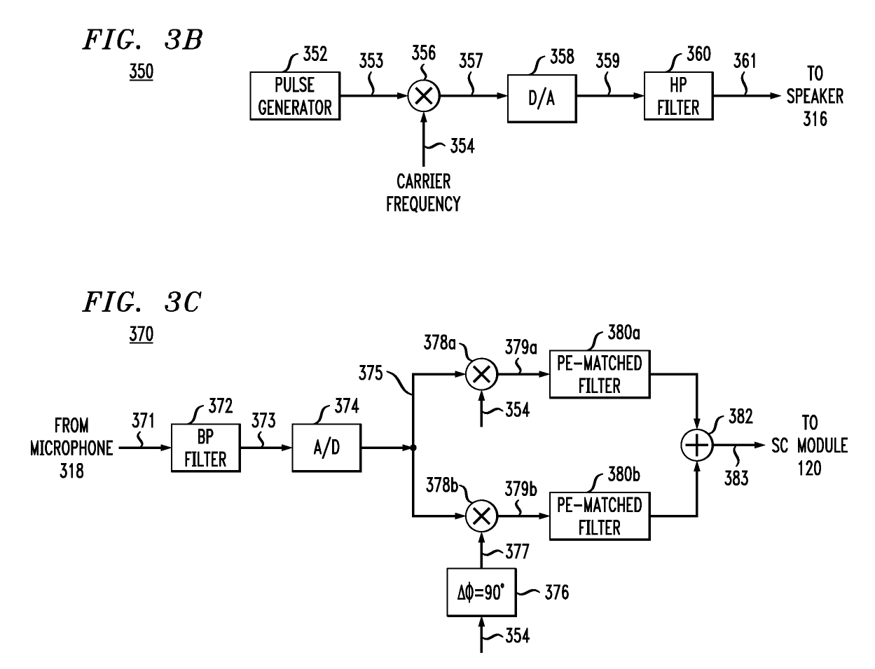

FIGS. 3A-C show a cell phone 300 that can be used as transceiver 108 according to one embodiment of the invention. More specifically, FIG. 3A shows a perspective three-dimensional view of cell phone 300 in an unfolded state. FIG. 3B shows a block diagram of a drive circuit 350 that is used in cell phone 300 to drive an STA speaker 316. FIG. 3C shows a block diagram of a detect circuit 370 that is used in cell phone 300 to convert an analog output signal generated by an STA microphone 318 into digital form.

Referring to FIG. 3A, cell phone 300 has a base 302 and flip-out panels 304 and 310, each pivotally connected to the base. Base 302 has a conventional acoustic microphone 312 and might contain drive circuit 350 of FIG. 3B and/or detect circuit 370 of FIG. 3C. Panel 304 has a display screen (e.g., an LCD) 306. Panel 310 has an STA package 314 that includes STA speaker 316 and STA microphone 318. A hinge 308 that pivotally connects panel 310 to base 302 provides appropriate electrical connections for STA package 314. For example, hinge 304 might provide electrical connections that carry (i) power-supply voltages/currents and control signals from base 302 to STA package 314 and (ii) echo signals from the STA package to the base. Hinge 308 also enables the user (e.g., person 102 in FIG. 1) to place STA package 314 in front of her mouth during a communication session and to fold panel 310 back into base 302 when the communication session is over. The communication session can be a silent-speech or a normal-speech communication session.

STA speaker 316 is designed to periodically (e.g., with a repetition rate of about 50 Hz or higher) or non-periodically emit short (e.g., shorter than about 1 ms) bursts of STA waves for probing the configuration of the user's vocal tract. In a representative configuration, a burst of STA waves enters the vocal tract through the slightly open mouth of the user and undergoes multiple reflections within the various cavities of the vocal tract. The reflected STA waves interfere with each other to form a decaying echo signal, which is picked up by STA microphone 318. In one embodiment, STA speaker 316 is a Model GC0101 speaker commercially available from Shogyo International Corporation of Syosset, N.Y., and STA microphone 318 is a Model SPM0204 microphone commercially available from Knowles Acoustics of Burgess Hill, United Kingdom. In various embodiments, various types of cell phones (e.g., non-foldable cell phones) can similarly be used to implement transceiver 108.

Referring to FIG. 3B, drive circuit 350 has a multiplier 356 that injects a carrier-frequency signal 354 into an excitation-pulse envelope 353 defined by a digital pulse generator 352. In various configurations, the carrier frequency can be selected, e.g., from a range between about 1 kHz and about 100 kHz. Excitation-pulse envelope 353 can have any suitable (e.g., Gaussian or rectilinear) shape and can further be modulated by a pseudo-noise waveform. An output 357 of multiplier 356 is digital-to-analog (D/A) converted in a D/A converter 358. A resulting analog signal 359 is passed through a high-pass (HP) filter 360, and a filtered signal 361 is used to drive STA speaker 316 (see FIG. 3A).

In one embodiment, cell phone 300 might be configured to use conventional microphone 312 or a separate dedicated microphone (not explicitly shown) to determine the level of ambient acoustic noise and use that information to configure pulse generator 352 to set the intensity and/or frequency of the excitation pulses emitted by STA speaker 316. Since it is desirable not to disturb other people around the user of cell phone 300, the physiological-perception threshold of those people, rather than that of the user, ought to be considered for setting the parameters of the STA emission. Since the spectral shape and location of a physiological-perception threshold curve generally depends on the characteristics of ambient acoustic noise (see the description FIG. 1B above), cell phone 300 can for example increase the intensity of excitation pulses without disturbing other people around the user of the cell phone when the level of ambient noise is relatively high. One skilled in the art will appreciate that more-powerful excitation pulses are generally beneficial in terms of the signal-to-noise ratio of the corresponding echo signals.

Referring to FIG. 3C, detect circuit 370 implements a homodyne-detection scheme that utilizes carrier-frequency signal 354 and its phase-shifted version 377 produced by passing the carrier-frequency signal through a phase shifter 376, which is configured to apply a phase shift of about 90 degrees (or, alternatively, about 270 degrees). An analog output signal 371 generated by STA microphone 318 (see FIG. 3A) is passed through a bandpass (BP) filter 372. A resulting filtered signal 373 is converted into digital form in an analog-to-digital (A/D) converter 374. A digital signal 375 generated by A/D converter 374 is subjected to homodyne detection by being mixed in multipliers 378a-b with carrier-frequency signal 354 and its phase-shifted version 377, respectively, to generate a real part 379a and an imaginary part 379b, respectively, of the homodyne-detected signal. Pulse-envelope (PE) matched filters 380a-b filter the real and imaginary parts, respectively, to reduce the influence of the excitation-pulse envelope on the detected echo signal. An adder 382 sums the filtered signals produced by PE-matched filters 380a-b to produce a digital echo signal 383. One skilled in the art will appreciate that the use of filters 380a-b cause digital echo signal 383 to be a function of a current configuration of the vocal tract and not a function of the excitation-pulse envelope.

One skilled in the art will appreciate that drive circuit 350 and detect circuit 370 are merely exemplary circuits. In various embodiments, other suitable drive and detect circuits can similarly be used in cell phone 300 without departing from the scope and principles of the invention.

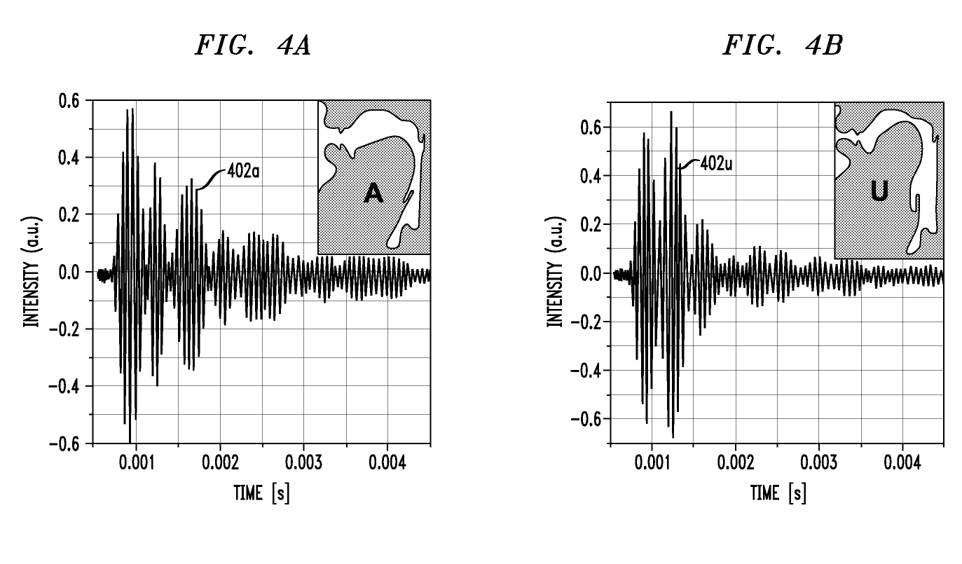

FIGS. 4A-B graphically show two representative echo signals detected by cell phone 300. More specifically, echo signal 402a of FIG. 4A was detected when the user silently spoke the vowel “ah”. The insert in FIG. 4A depicts a vocal-tract shape corresponding to that silent vowel. Similarly, echo signal 402u of FIG. 4B was detected when the user silently spoke the vowel “yu”. The insert in FIG. 4B depicts a vocal-tract shape corresponding to that silent vowel. As can be seen, echo signals 402a and 402u differ significantly, as do the corresponding vocal-tract shapes. The differences between echo signals 402a and 402u enable SC module 120 (FIG. 1) to recognize that the vowels “ah” and “yu,” respectively, have been silently spoken by the user. One skilled in the art will appreciate that STA package 314 will generally generate different echo signals for different silently spoken vowels, consonants, fricatives, and approximants (i.e., speech sounds that are regarded as being intermediate between a typical vowel and a typical consonant). Using this property of echo signals, communication system 100 (FIG. 1) can appropriately process a stream of echo signals generated by STA package 314 during a silent-speech session to phonate the corresponding silent speech.

One skilled in the art will appreciate that echo signals analogous to echo signals 402 are produced when the user speaks audibly, rather than silently. As already indicated above, the vocal-tract configuration corresponding to a speech phone spoken silently is substantially the same as the vocal-tract configuration corresponding to the same speech phone spoken audibly, except that, during the silent speech, the vocal folds are not vibrating. As used herein, the term “speech phone” refers to a basic unit of speech revealed via phonetic speech analysis and possessing distinct physical and/or perceptual characteristics. For example, each of the different vowels and consonants used to convey human speech is a speech phone. Since an echo signal is a function of the geometry of the various cavities in the vocal tract and depends very little on whether the vocal folds are vibrating or not vibrating, an echo signal that is substantially similar to echo signal 402a is produced when the user speaks the vowel “ah” audibly, rather than silently. Similarly, an echo signal substantially similar to echo signal 402u is produced when the user speaks the vowel “yu” audibly, rather than silently. In general, a substantial similarity between the echo signals corresponding to silent and normal speech exists for other speech phones as well.

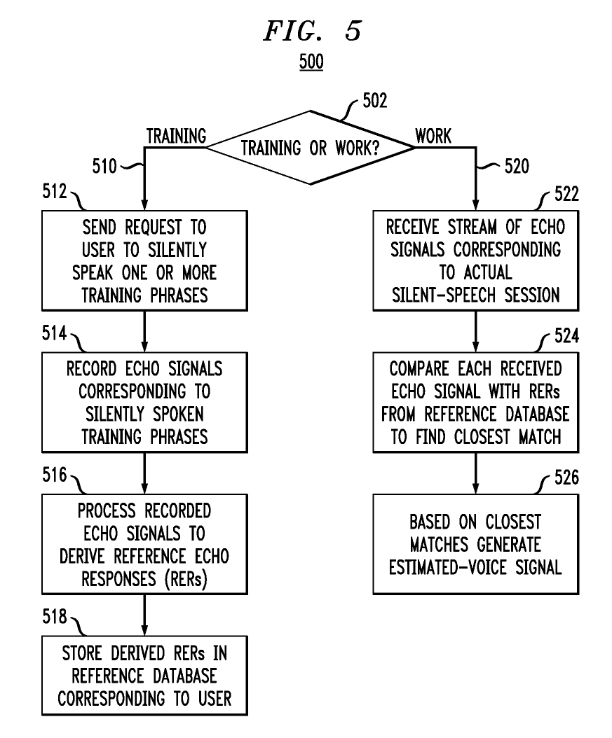

FIG. 5 shows a flowchart of a signal-processing method 500 that can be used in SC module 120 (FIG. 1) according to one embodiment of the invention. Although method 500 is described below in reference to silent speech, it can similarly be used for normal speech, e.g., when the normal speech is burdened by a significant acoustic noise. To obtain a flowchart of an embodiment of method 500 corresponding to normal speech, the reader can substitute the terms “silent speech” and “silently spoken” by the terms “audible speech” and “audibly spoken,” respectively, in the corresponding text boxes of FIG. 5. A representative embodiment of method 500 can be implemented using cell phone 300 (FIG. 3).

Method 500 has branches 510 and 520 corresponding to two different operating modes of SC module 120. If SC module 120 is in a “training” mode, then the processing of method 500 is directed by a mode-switch 502 to training branch 510 having steps 512-518. If SC module 120 is in a “work” mode, then the processing of method 500 is directed by mode-switch 502 to work branch 520 having steps 522-526. In one implementation, a user of cell phone 300 can generally manually reconfigure mode switch 502 from one mode to the other.

In the training mode, SC module 120 is configured to collect user-specific reference data that can then be used to process echo signals originating from that particular user during a subsequent occurrence of the work mode. If two or more different users intend to use the VE interface functionality of cell phone 300 at different times, then separate training sessions might be conducted for each individual user to collect the corresponding user-specific reference data. Cell phone 300 having multiple users might be configured to use an appropriate user-login procedure to be able to identify the current user and relay that identification to SC module 120.

At step 512 of training branch 510, SC module 120 sends a request to the user to silently speak one or more training phrases. A training phrase can be a sentence, a word, a syllable, or an individual speech sound. Each training phrase might have to be repeated several times to sample the natural speech variance inherent to that particular user. SC module 120 might use display screen 306 of cell phone 300 to convey to the user the contents of the training phrases and the appropriate speaking instructions.

At step 514, SC module 120 records a series of echo signals detected by cell phone 300 while the user silently speaks the various training phrases specified at step 512. Each of the recorded echo signals is generally analogous to echo signal 402 shown in FIG. 4.

At step 516, SC module 120 processes the recorded echo signals to derive a plurality of reference echo responses (RERs). In one embodiment, each RER represents a different respective speech phone. SC module 120 might generate each RER by temporally aligning and then intensity averaging a plurality of echo signals corresponding to different occurrences of the same speech phone in the training phrase(s). In other embodiments of step 516, SC module 120 processes the recorded echo signals to more generally define a mapping procedure for mapping a signal space corresponding to echo signals onto a signal space corresponding to audio signals of the user's speech.

Note that each RER normally corresponds to a phoneme. As used herein, the term “phoneme” refers to a smallest unit of potentially meaningful sound within a given language's system of recognized sound distinctions. Each phoneme in a language acquires its identity by contrast with other phonemes for which it cannot be substituted without potentially altering the meaning of a word. For example, recognition of a difference between the words “level” and “revel” indicates a phonemic distinction in the English language between /l/ and /r/ (in transcription, phonemes are indicated by two slashes). Unlike a speech phone, a phoneme is not an actual sound, but rather, is an abstraction representing that sound.

Two or more different RERs can correspond to the same phoneme. For example, the “t” sounds in the words “tip,” “stand,” “water,” and “cat” are pronounced somewhat differently and therefore represent different speech phones. Yet, each of them corresponds to the same /t/. Furthermore, substantially the same perceptible audio sound (which corresponds to a plurality of audio sounds that are within the error bar of sound perception by the human ear) can be represented by several noticeably different RERs because that perceptible audio sound can generally be produced by several different configurations of the voice tract. The training phrases used at step 514 are preferably designed so that the phoneme corresponding to each particular RER is relatively straightforward to determine.

At step 518, SC module 120 stores the RERs generated at step 516 in a reference database corresponding to the user. As further explained below, the RERs and their corresponding phonemes are invoked during the signal processing implemented in work branch 520.

At step 522 of work branch 520, SC module 120 receives a stream of echo signals detected by cell phone 300 during an actual (i.e., non-training) silent-speech session. Each of the received echo signals is generally analogous to echo signal 402 shown in FIG. 4.

At step 524, SC module 120 compares each of the received echo signals with the RERs stored at step 518 in a reference database to determine a closest match. In one embodiment, the closest match is determined by calculating a plurality of cross-correlation values, each based on a cross-correlation function between the echo signal and an RER. A cross-correlation value can be calculated, e.g., by (i) temporally aligning the echo signal and the RER; (ii) sampling each of them at a specified sampling rate, e.g., about 500 samples per millisecond; (iii) multiplying each sample of the echo signal by the corresponding sample of the RER; and (iv) summing up the products. Generally, the RER corresponding to a highest correlation value is deemed to be the closest match, provided that said correlation value is higher than a specified threshold value. If all calculated cross-correlation values fall below the threshold value, then the corresponding echo signal is deemed to be non-interpretable and is discarded.

In alternative embodiments of step 524, other suitable signal-processing techniques can be used to determine a closest match for each received echo signal. For example, spectral-component analyses, artificial neural-network processing, and/or various signal cross-correlation techniques can be utilized without departing from the scope and principles of the invention.

At step 526, based on the sequence of closest matches determined at step 524, SC module 120 generates an estimated-voice signal corresponding to the silent-speech session. In one embodiment, the estimated-voice signal is a sequence of time-stamped phonemes corresponding to the closest RER matches determined at step 524. Note that each phoneme is time-stamped with the time at which the corresponding echo signal was detected by cell phone 300.

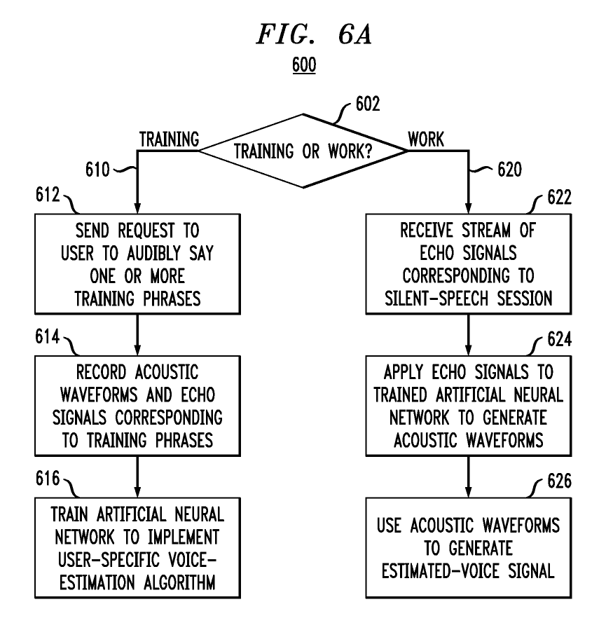

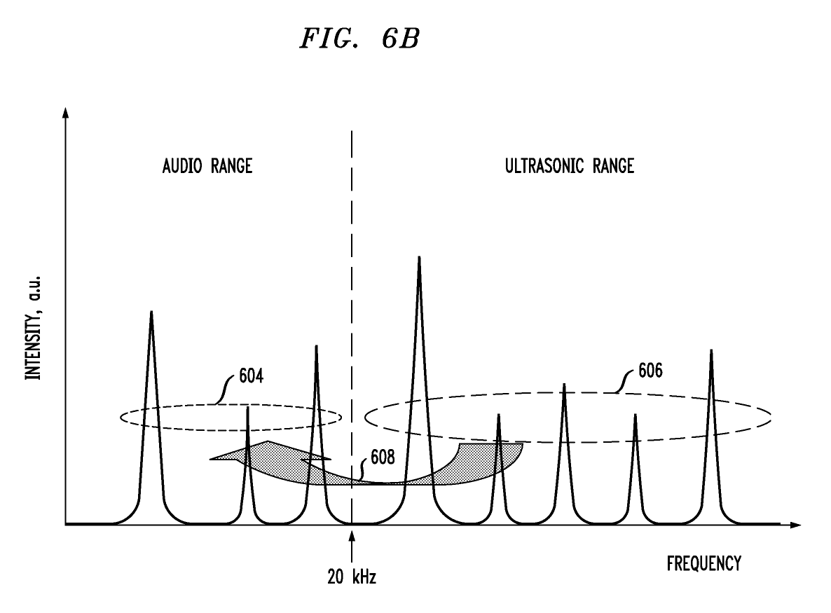

FIGS. 6A-B illustrate a signal-processing method 600 that can be used in SC module 120 (FIG. 1) according to another embodiment of the invention. More specifically, FIG. 6A shows a flowchart of method 600. FIG. 6B graphically illustrates a voice-estimation algorithm that can be used in one implementation of method 600. Similar to method 500, method 600 is applicable to both silent and audible speech. If applied to audible speech, method 600 is particularly beneficial when the audible speech is significantly burdened by ambient acoustic noise.

Referring to FIG. 6A, signal-processing method 600 is similar to signal-processing method 500 (FIG. 5) in that it has two branches, i.e., a training branch 610 and a work branch 620. A mode-switch 602 controls whether the processing of method 600 is directed to training branch 610 or work branch 620. If SC module 120 is in a “training” mode, then the processing of method 600 is directed to training branch 610 having steps 612-616. If SC module 120 is in a “work” mode, then the processing of method 600 is directed to work branch 620 having steps 622-626.

At step 612 of training branch 610, SC module 120 sends a request to the user to audibly (e.g., in a normal manner) say one or more training phrases. Each training phrase might have to be repeated several times to sample the natural speech variance inherent to that particular user. SC module 120 might use display screen 306 of cell phone 300 to convey to the user the contents of the training phrases and the appropriate speaking instructions.

At step 614, SC module 120 records a series of audio waveforms and a corresponding series of echo signals corresponding to the various training phrases specified at step 612. The audio waveforms are generated by conventional acoustic microphone 312 as it picks up the sound of the user's voice. At the same time, STA package 314 picks up the STA echo signals from the user's voice tract. BP filter 372 (see FIG. 3C) helps to prevent the audio waveforms from interfering with and/or contributing to the STA echo signals recorded by SC module 120.

At step 616, an artificial neural network of SC module 120 is trained using the audio waveforms and echo signals recorded at step 614 to implement a voice-estimation algorithm. In one embodiment, an echo signal is Fourier-transformed to generate a corresponding spectrum. As an example, FIG. 6B shows an (illustratively) ultrasonic spectrum 606 of a detected echo signal. SC module 120 performs a spectral transform indicated in FIG. 6B by arrow 608 that converts ultrasonic spectrum 606 into an audio spectrum 604. Acoustic spectrum 604 is such that a cepstrum of that spectrum approximates the audio waveform that was recorded together with the echo signal at step 614. In general, parameters of the artificial neural network are selected so that, if an STA echo signal is applied to the input of the artificial neural network, then an audio waveform that closely approximates the corresponding recorded audio waveform appears at its output. In other words, the artificial neural network is trained to map a space of echo signals onto a space of audio waveforms. The training process for the artificial neural network continues until it has been trained to correctly perform a sufficiently large number of transforms analogous to spectral transform 608 and satisfactorily operates over a signal space that covers the various speech phones and phonemes corresponding to the training phrases of step 612.

As further explained below, the trained artificial neural network of SC module 120 produced at step 616 is used during the signal processing implemented in work branch 620. In a representative embodiment, the artificial neural network might have about 500 artificial neurons organized in one or more neuron layers. A suitable processor that can be used to implement an artificial neural network in SC module 120 is disclosed, e.g., in U.S. Patent Application Publication No. 2008/0154815, which is incorporated herein by reference in its entirety.

At step 622 of work branch 620, SC module 120 receives a stream of echo signals detected by cell phone 300 during a silent-speech session. Each of the received echo signals is generally analogous to echo signal 402 shown in FIG. 4.

At step 624, each of the received echo signals is applied to the trained artificial neural network to generate a corresponding audio waveform.

At step 626, SC module 120 uses the audio waveforms generated at step 624 are used to generate an estimated-voice signal corresponding to the silent-speech session. Additional speech-synthesis techniques might be employed in SC module 120 and/or signal processor 130 to further manipulate (e.g., merge, filter, discard, etc.) the audio waveforms to ensure that synthesized sound 142 has a relatively high quality.

In various embodiments, various features of methods 500 and 600 can be utilized to create an alternative signal-processing method that can be employed in SC module 120 and/or signal processor 130. For example, a signal processing method that does not have a training branch is contemplated. More specifically, earpiece 122 (see FIG. 1A) can be used to feed the sound corresponding to the estimated-voice signal back to the user. Based on that sound, the user can adjust the manner of her silent or normal speech so that sound 142 at the remote receiver has the desired audio characteristics. One skilled in the art will appreciate that SC module 120 can invoke various embodiments of signal processing methods 500 and 600 that are specifically tailored to processing echo signals corresponding to silent speech, normal speech, or noise-burdened speech.

Referring back to FIG. 1, as already indicated above, in addition to an STA package (such as STA package 314), VE interface 110 (FIG. 1) or panel 310 (FIG. 3) might include one or more additional sensors whose signals can be used to improve the quality of synthesized sound 142. For example, a video camera can be used to implement a lip-reading technique that can be viewed as being analogous to that used by the deaf. A video signal recorded by the video camera can be sent via a network, to which cell phone 300 is connected, to a relatively powerful computer where the video information can be processed to generate a corresponding sequence of time-stamped phonemes. This video-based sequence of phonemes can be used in conjunction with the STA-based sequence of phonemes, e.g., to resolve ambiguities or to fill in the gaps corresponding to non-interpretable STA echo signals. The sequences of time-stamped phonemes produced based on the data generated by other types of sensors, such as the infrared, millimeter-wave, electromyographic, and electromagnetic articulographic, can similarly be utilized to improve the quality of synthesized sound 142.

In one embodiment, an STA package (such as STA package 314, FIG. 3)) might have an array of STA speakers analogous to STA speaker 316 and/or an array of STA microphones analogous to STA microphone 318. Having arrayed STA speakers and/or microphones can be beneficial, e.g., because arrayed STA speakers can be used for excitation-beam shaping through interference effects and arrayed STA microphones can enable more sophisticated signal processing that provides more accurate information about the configuration of the user's vocal tract. Excitation coding, e.g., analogous to the coding used in CDMA, can be used to further improve the interpretability of echo signals.

Various embodiments of system 100 can advantageously be used to phonate silent speech produced (i) in a noisy or socially sensitive environment; (ii) by a disabled person whose vocal tract has a pathology due to a disease, birth defect, or surgery; and/or (iii) during a military operation, e.g., behind enemy lines. Alternatively or in addition, various embodiments of system 100 can advantageously be used to improve the perception quality of normal speech when it is burdened by ambient acoustic noise. For example, if the noise level is relatively tolerable, then STA package 314 can be used as a secondary sensor to enhance the voice signal produced by conventional acoustic microphone 312. If the noise level is intermediate between relatively tolerable and intolerable, then acoustic microphone 312 can be used as a secondary sensor to enhance the quality of the estimated-voice signal generated based on the echo signals picked up by STA package 314. If the noise level is intolerable, then acoustic microphone 312 can be turned off, and the estimated-voice signal can be generated solely based on the echo signals picked up by STA package 314. In one embodiment, STA package 314 can be installed in a mouthpiece of scuba-diving gear, e.g., to enable a scuba diver to talk to other scuba divers and/or to the people that monitor the dive from a boat. The scuba diver can use a speaking technique that is similar to silent speech to produce audible speech at the intended receiver.

While this invention has been described with reference to illustrative embodiments, this description is not intended to be construed in a limiting sense. Various modifications of the described embodiments, as well as other embodiments of the invention, which are apparent to persons skilled in the art to which the invention pertains are deemed to lie within the principle and scope of the invention as expressed in the following claims.

Certain embodiments of the present invention may be implemented as circuit-based processes, including possible implementation on a single integrated circuit. As would be apparent to one skilled in the art, various functions of circuit elements may also be implemented as processing steps in a software program. Such software may be employed in, for example, a digital signal processor, micro-controller, or general-purpose computer.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this invention may be made by those skilled in the art without departing from the scope of the invention as expressed in the following claims.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

What is claimed is:

1. An apparatus, comprising:
a voice-estimation (VE) interface adapted to probe a vocal tract of a user; and
a signal-converter (SC) module operatively coupled to the VE interface and adapted to process one or more signals produced by the VE interface to generate an estimated-voice signal corresponding to the user, wherein:
the VE interface comprises a sub-threshold acoustic (STA) package adapted to direct STA bursts to the vocal tract and detect echo signals corresponding to said STA bursts; and
the estimated-voice signal is based on the echo signals.

2. The invention of claim 1, wherein the echo signals correspond to silent speech of the user.

3. The invention of claim 1, wherein the VE interface is implemented in a cell phone.

4. The invention of claim 3, wherein the SC module is implemented in the cell phone.

5. The invention of claim 3, wherein the SC module is implemented on a server of a network to which the cell phone is connected.

6. The invention of claim 1, wherein the STA package comprises:
an STA speaker adapted to generate an excitation pulse having an envelope shape and a carrier frequency; and
an STA microphone adapted to pick up from the vocal tract a response signal corresponding to said excitation pulse and containing an echo signal.

7. The invention of claim 6, wherein the carrier frequency is greater than about 20 kHz.

8. The invention of claim 6, wherein:
the carrier frequency is in a range between about 20 Hz and about 20 kHz; and
the excitation pulse has an intensity that is below a physiological-perception threshold.

9. The invention of claim 1, wherein the SC module is adapted to:
collect reference data during a training session; and
use the reference data during a work session to generate the estimated-voice signal.

10. The invention of claim 9, wherein, during the training session, the SC module:
sends a request to the user to silently or audibly speak one or more training phrases while the STA package is probing the vocal tract of the user; and
processes echo signals corresponding to the one or more training phrases to derive a plurality of reference echo responses (RERs), wherein the reference data comprise said plurality of RERs.

11. The invention of claim 9, wherein:
the reference data comprise a plurality of reference echo responses (RERs); and
during the work session, the SC module:
receives a stream of echo signals corresponding to the user; and
compares each received echo signal with the RERs to generate the estimated-voice signal.

12. The invention of claim 9, wherein, during the training session, the SC module:
sends a request to the user to audibly say one or more training phrases while the STA package is probing the vocal tract of the user; and
processes acoustic waveforms and echo signals corresponding to the one or more training phrases to enable that the SC module to map a space of echo signals onto a space of audio signals, wherein the reference data comprise one or more parameters of said mapping.

13. The invention of claim 9, wherein:
the reference data comprise one or more parameters of a voice-estimation algorithm that maps a space of echo signals onto a space of audio signals; and
during the work session, the SC module:
receives a stream of echo signals corresponding to the user; and
applies the voice-estimation algorithm to the received echo signals to generate the estimated-voice signal.

14. The invention of claim 1, wherein the estimated-voice signal comprises a sequence of time-stamped audio waveforms generated based on the echo signals.

15. The invention of claim 1, wherein the estimated-voice signal comprises a sequence of time-stamped phonemes generated based on the echo signals.

16. The invention of claim 1, wherein:
the VE interface further comprises one or more sensors, each adapted to probe the vocal tract; and
the SC module is adapted to use one or more signals produced by the one or more sensors in the generation of the estimated-voice signal.

17. The invention of claim 16, wherein the one or more signals produced by the one or more sensors are used in the SC module to improve accuracy of the estimated-voice signal compared to accuracy attainable based solely on the echo signals.

18. The invention of claim 16, wherein the one or more sensors comprise one or more of a video camera, an infrared sensor or imager, a millimeter-wave sensor, an electromyographic sensor, and an electromagnetic articulographic sensor.

19. The invention of claim 1, further comprising an earpiece adapted to phonate the estimated-voice signal and feed a resulting sound to the user.

20. A method of estimating voice, comprising:
probing a vocal tract of a user using a voice-estimation (VE) interface; and
processing one or more signals produced by the VE interface to generate an estimated-voice signal corresponding to the user, wherein:
the VE interface comprises a sub-threshold acoustic (STA) package adapted to direct STA bursts to the vocal tract and detect echo signals corresponding to said STA bursts; and
the estimated-voice signal is based on the echo signals.
